(19) United States
(12) Patent Application Publication
(10) Pub. No.: US 2017/0243327 A1
(43) Pub. Date: Aug. 24, 2017

(54) DETERMINING WHETHER TO ROTATE CONTENT BASED ON IDENTIFICATION OF ANGULAR VELOCITY AND/OR ACCELERATION OF DEVICE

(71) Applicant: Lenovo (Singapore) Pte. Ltd., New Tech Park (SG)

(72) Inventors: Jianbang Zhang, Cary, NC (US); Jian Li, Chapel Hill, NC (US); Russell Speight VanBlon, Raleigh, NC (US); Grigori Zaitsev, Durham, NC (US)

(21) Appl. No.: 15/048,769

(22) Filed: Feb. 19, 2016

(51) Int. Cl. G06T 3/60; G06F 3/01

(52) U.S. Cl. CPC G06T 3/60; G06F 3/017

(57) ABSTRACT

In one aspect, a device includes a processor, a motion sensor accessible to the processor, a display accessible to the processor, and storage accessible to the processor. The storage bears instructions executable by the processor to identify one or more of an angular velocity of the device and an acceleration of the device based at least in part on input from the motion sensor, and determine whether to rotate content presented on the display based at least in part on the identification.

### FIELD

The present application relates generally to determining whether to rotate content presented on a display based on identification of angular velocity and/or acceleration of a device.

### BACKGROUND

As recognized herein, content presented on a display may be rotated based on an angle at which a user is holding a device on which the content is presented. However, as also recognized herein, this can lead to unintended rotations if the user accidentally and/or temporarily reorients the device. There are currently no adequate solutions to the foregoing.

### SUMMARY

Accordingly, in one aspect a device includes a processor, a motion sensor accessible to the processor, a display accessible to the processor, and storage accessible to the processor. The storage bears instructions executable by the processor to identify one or more of an angular velocity of the device and an acceleration of the device based at least in part on input from the motion sensor, and determine whether to rotate content presented on the display based at least in part on the identification.

In another aspect, a method includes identifying one or more of an angular velocity of a device and an acceleration of the device and determining whether to rotate content presented on a display based at least in part on the identifying.

In still another aspect, an apparatus includes a first processor, a network adapter, and storage. The storage bears instructions executable by a second processor of a device for identifying one or more of an acceleration of the device and an angular velocity of the device in at least two dimensions and determining whether to adjust presentation of content presented on a display of the device based at least in part on the identifying. The first processor transfers the instructions to the second processor over a network via the network adapter.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIG. 3 is a flow chart of an example algorithm in accordance with present principles;

FIG. 4 shows an example data table in accordance with present principles; and

FIGS. 5 and 6 show example user interfaces (UIs) in accordance with present principles.

### DETAILED DESCRIPTION

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by, e.g., a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g., that is not a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

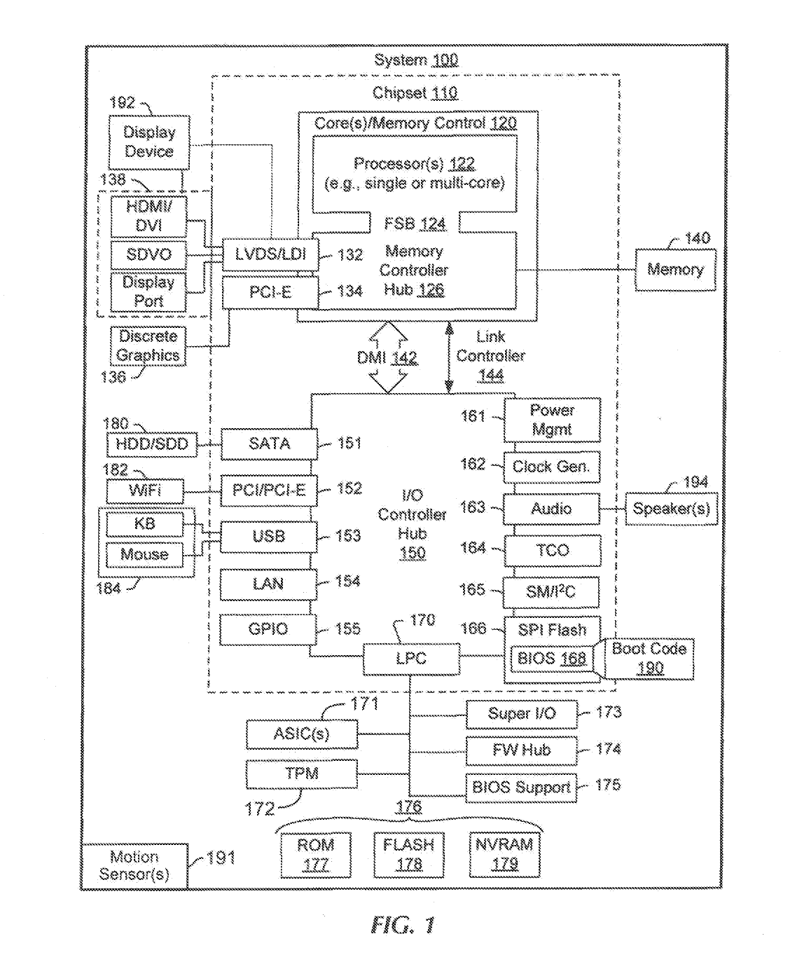

Now specifically in reference to FIG. 1, an example block diagram of an information handling system and/or computer system 100 is shown. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX® or Playstation®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video. HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

In addition to the foregoing, the system 100 may include one or more motion sensors 191 such as a gyroscope that senses and/or measures the orientation of the system 100 and provides input related thereto to the processor 122, an accelerometer that senses acceleration and/or movement of the system 100 and provides input related thereto to the processor 122, another inertial sensor such as a magnetometer that senses motion of the system 100 and provides input related thereto to the processor 122, etc.

The system 100 may also include an audio receiver/microphone that provides input to the processor 122 based on audio that is detected, such as via a user providing audible input to the microphone, and a camera that gathers one or more images and provides input related thereto to the processor 122. The camera may be a thermal imaging camera, a digital camera such as a webcam, a three-dimensional (3D) camera, and/or a camera otherwise integrated into the system 100 and controllable by the processor 122 to gather pictures/images and/or video. Still further, and also not shown for clarity, the system 100 may include a GPS transceiver that is configured to receive geographic position information from at least one satellite and provide the information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

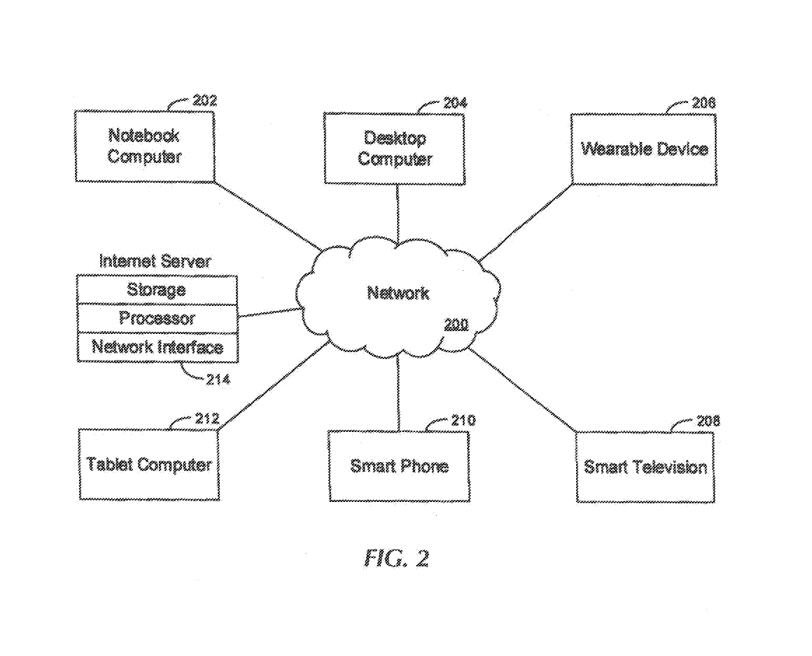

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles.

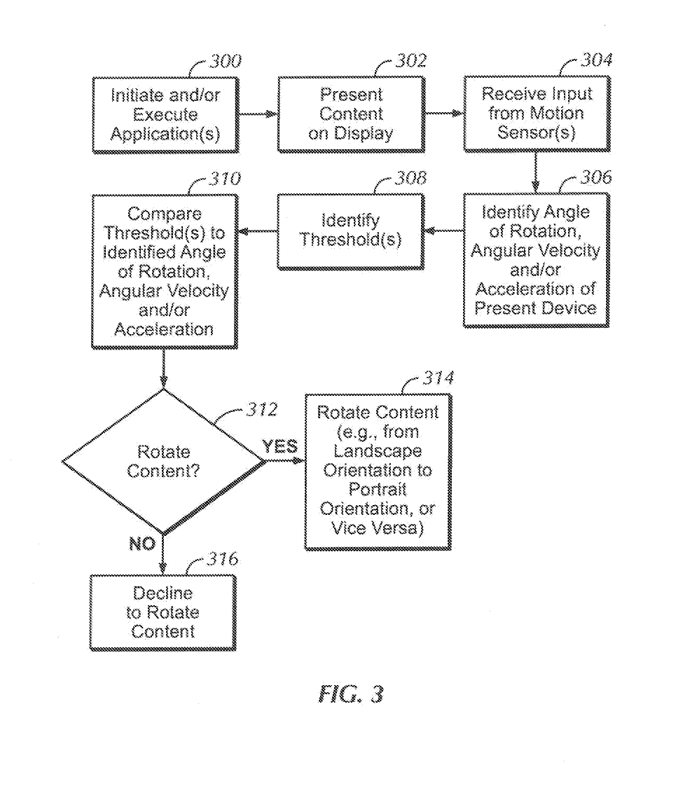

Referring to FIG. 3, it shows example logic that may be executed by a device such as the system 100 in accordance with present principles (referred to when describing FIG. 3 as the “present device”). Beginning at block 300, the logic initiates and/or executes one or more applications for undertaking present principles, such as an application to present content on a display of the present device, an application to rotate content between landscape and portrait orientations, an application to identify angles of rotation of the present device, acceleration of the present device, and angular velocity of the present device, etc.

From block 300 the logic may proceed to block 302, where the logic may present content on the present device's display. The content may be any number of things, including a website, a video or still image, an application home screen, the present device's home screen, text or a word processing document, still other data, etc. Regardless, after block 302 the logic may next proceed to block 304.

At block 304 the logic may receive input from one or more motion sensors on the present device, such as input from a gyroscope on the present device and input from an accelerometer on the present device. After block 304 the logic may then proceed to block 306.

At block 306 the logic may identify, based on the input received at block 304, one or more of an actual angle of rotation of the present device resulting from a rotation of the present device, angular velocity of the present device as it is rotated, and acceleration of the present device as it is rotated. The angle of rotation, angular velocity, and/or acceleration may be identified using a motion sensor signal processing algorithm executed by the present device's processor to analyze and/or process signals from the motion sensor and output values for one or more of the angle of rotation, angular velocity, and acceleration.

Before moving on in the description of FIG. 3, it is to be understood that the angle of rotation may be detected as an angle that the present device is or was rotated in two dimensions, such as along X and Y axes of the present device, along a plane established by the display, at least substantially along the plane established by the display save for minimal and/or negligible movement in the third dimension as the user rotates the device in the other two dimensions, etc. Angular velocity and acceleration may be similarly determined in two dimensions.

Also before moving on in the description of FIG. 3, it is to be understood that since angular velocity and/or acceleration may not be constant throughout the rotation of the device, the highest value during rotation for angular velocity and/or acceleration may be identified at block 306 and used in accordance with present principles, the lowest value during rotation for angular velocity and/or acceleration may be identified at block 306 and used in accordance with present principles, and/or an average (e.g., mean, median, or mode) during rotation for angular velocity and/or acceleration may be identified at block 306 and used in accordance with present principles.

Still in reference to FIG. 3, from block 306 the logic may next move to block 308 where the logic may identify one or more thresholds to use in accordance with present principles. The threshold(s) may be an angle of rotation threshold, an angular velocity threshold, and/or an acceleration threshold. In some embodiments, the threshold(s) may be fixed and/or unchanging regardless of detected amounts of acceleration and/or angular velocity, and may be stored at a location accessible to the present device such as in storage on the present device itself.

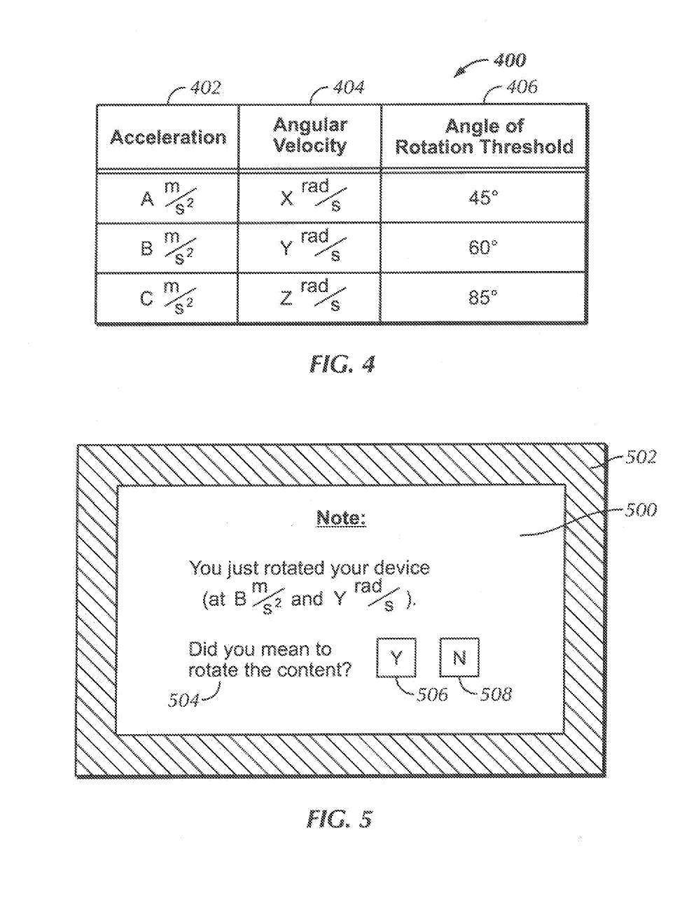

However, it is to be understood that for at least the angle of rotation threshold, in some embodiments it may vary based on the angular velocity and/or acceleration identified at block 306. Thus, for instance, a data table accessible to the present device (e.g., stored at the present device) may be accessed once the angular velocity and/or acceleration have been identified at block 306 to identify an angle of rotation threshold to use that is correlated in the data table to an angular velocity and/or acceleration (or, angular velocity range and/or acceleration range) matching the one(s) identified at block 306. An example of such a data table will be described below in reference to FIG. 4.

However, still in reference to FIG. 3, from block 308 the logic may proceed to block 310. At block 310 the logic may compare the identified threshold(s) to the identified actual angle of rotation, angular velocity, and/or acceleration. The logic may then move to decision diamond 312 where the logic may determine, based on the comparison(s), whether to rotate the content presented on the display. An affirmative determination at diamond 312 may cause the logic to next move to block 314, where the logic may rotate the content presented on the display, such as from a landscape orientation to a portrait orientation, or vice versa. However, note that a negative determination at diamond 312 may instead cause the logic to move to block 316, where the logic may decline to rotate the content presented on the display (and thus continue to present it in the orientation initially used at block 302, e.g., either landscape or portrait).

The comparison(s) at block 310 and corresponding determination at diamond 312 may be based on whether the identified angular velocity of the present device is at least one of equal to and greater than the identified angular velocity threshold (in which case an affirmative determination may be made at diamond 312, and if not then a negative determination may be made at diamond 312), whether the identified angular velocity of the present device is at least one of equal to and less than the identified angular velocity threshold (in which case an affirmative determination may be made at diamond 312, and if not then a negative determination may be made at diamond 312), whether the identified acceleration of the present device is at least one of equal to and greater than the identified acceleration threshold (in which case an affirmative determination may be made at diamond 312, and if not then a negative determination may be made at diamond 312), and/or whether the identified acceleration of the present device is at least one of equal to and less than the identified acceleration threshold (in which case an affirmative determination may be made at diamond 312, and if not then a negative determination may be made at diamond 312).

Thus, it is to be understood that in some embodiments, the identified angular velocity and/or acceleration may be above the corresponding threshold to result in an affirmative determination at diamond 312, while in other embodiments the identified angular velocity and/or acceleration may be below the corresponding threshold to result in an affirmative determination at diamond 312. Which one to employ in a given situation may be determined based on, e.g., administrator-configured settings, manufacturer-configured settings, and/or user-configured settings (such as via user manipulation of a settings user interface (UI) for the present device such as the one to be described below in reference to FIG. 6). For instance, one user may desire that relatively slower device rotations result in a content rotation while relatively faster device rotations do not, and configure the present device accordingly, while another user may desire that relatively faster device rotations result in a content rotation while relatively slower device rotations do not, and configure the present device accordingly.

Also in some embodiments, affirmative determinations pertaining to both the angular velocity and acceleration thresholds may be made in order to result in the logic proceeding to block 314, while in other embodiments only one need be met to result the logic proceeding to block 314. This too may be based on administrator-configured settings, manufacturer-configured settings, and/or user-configured settings.

In addition to or in lieu of the foregoing, the comparison(s) at block 310 and corresponding determination at diamond 312 may also be based on whether the identified actual angle of rotation of the present device is at least one of equal to and greater than the identified angle of rotation threshold (whether this threshold be fixed or determined based on the identified acceleration and/or angular velocity of the present device), and if it is, an affirmative determination may be made at diamond 312. If not, a negative determination may be made at diamond 312

Continuing the detailed description in reference to FIG. 4, it shows an example data table 400 that may be used by a device undertaking present principles, such as a device executing the logic of FIG. 3 discussed above. The data table 400 includes a first column 402 listing various accelerations (and/or acceleration ranges), a second column 404 listing various angular velocities (and/or angular velocity ranges), and a third column 406 listing various angle of rotation thresholds correlated to the various accelerations and/or various angular velocities. It is to be understood that variables (A, B, C and X, Y, Z) are being used in FIG. 4 for illustration, but that actual numbers may be included in such a table when the table is stored and used by a device in accordance with present principles.

Providing an example of how the table 400 may be used, a device undertaking present principles may identity an actual acceleration of it during a rotation, access the data table 400, parse data in column 402 until a match is identified of the actual acceleration to an acceleration listed in column 402 (or, if ranges are listed in the column 402, until a range is identified in which the identified actual acceleration falls), and then move horizontally over to a corresponding entry in column 406 to identify an angle of rotation threshold correlated to that acceleration (and/or acceleration range), which may then be used to make a determination such as the one described above in reference to block 312. For example, if an actual acceleration is identified as matching the second entry down in column 402 (“B” meters per second squared), the logic may proceed horizontally over to column 406 to identify that an angle of rotation threshold of sixty degrees is to be used in this example.

As another example of how the table 400 may be used, a device undertaking present principles may identify an actual angular velocity of it during a rotation, access the data table 400, parse data in column 404 until a match is identified of the actual angular velocity to an angular velocity listed in column 404 (or, if ranges are listed in the column 404, until a range is identified in which the identified actual angular velocity falls), and then move horizontally over to a corresponding entry in column 406 to identify an angle of rotation threshold correlated to that angular velocity (and/or angular velocity range), which may then be used to make a determination such as the one described above in reference to block 312. For example, if an actual angular velocity is identified as matching the third entry down in column 404 (“Z” radians per second), the logic may proceed horizontally over to column 406 to identify that an angle of rotation threshold of eighty five degrees is to be used in this example.

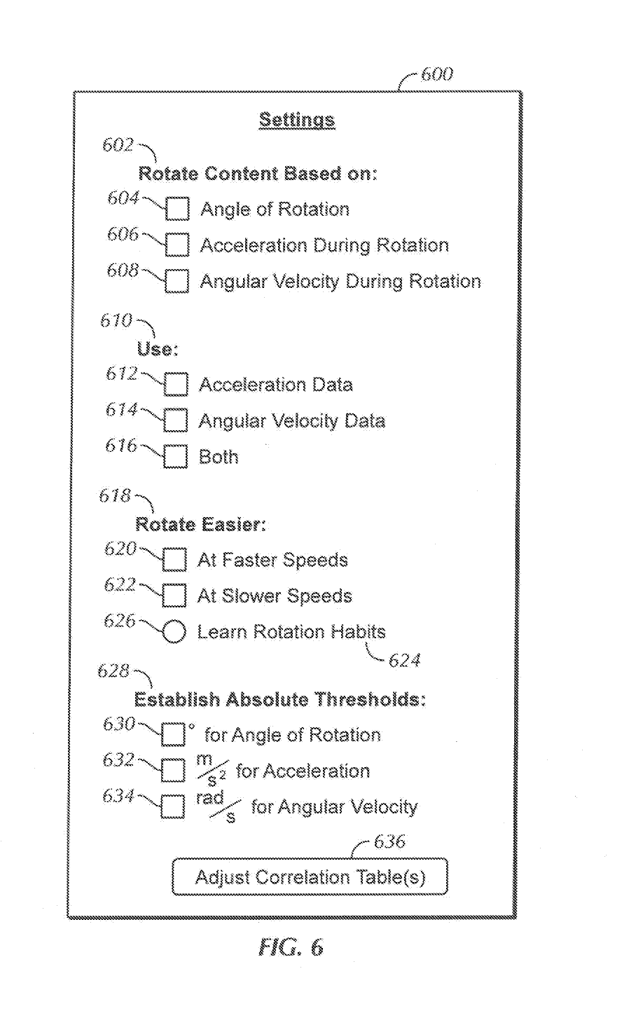

FIG. 5 will now be described. It shows an example user interface (UI) 500 presentable on a display of a device undertaking present principles so that a device may dynamically learn a user's intent to rotate content or not based on various device rotation amounts (e.g., the size of the angle in two dimensions from an initial device orientation to a rotated-to device orientation), and/or the acceleration and/or angular velocity with which the user rotates the device. The UI 500 may be overlaid on content 502, may be presented on the display responsive to the device detecting movement and/or a change in orientation of the device, and may include an indication that a user has just rotated the device. In some embodiments, the UI 500 may indicate the actual acceleration and/or actual angular velocity with which the device was rotated. The UI 500 may also include a prompt 504 asking whether the user meant to rotate the content 502 based on the detected device rotation.

Thus, a “yes” selector 506 is presented that is selectable by a user to provide input to the device that the user meant to rotate the content 502 based on the detected device rotation, while a “no” selector 508 is also presented that is selectable by a user to provide input to the device that the user did not mean to rotate the content 502 based on the detected device rotation. Fixed acceleration and/or angular velocity thresholds to be used in accordance with present principles may then be adjusted up or down accordingly based on the user input.

For example, if input is received via selector 506 that the user did intend to rotate the content 502, a fixed angle of rotation threshold may be adjusted (e.g., lowered) to result in a content rotation the next time the same (and/or a proximate) angle of rotation is detected, a fixed acceleration threshold may be adjusted (e.g., lowered) to result in a content rotation the next time the same (and/or a proximate) acceleration is detected, and/or a fixed angular velocity threshold may be adjusted (e.g., lowered) to result in a content rotation the next time the same (and/or a proximate) angular velocity is detected.

As another example, if input is received via selector 508 that the user did not intend to rotate the content 502, a fixed angle of rotation threshold may be adjusted (e.g., raised) to not result in a content rotation the next time the same (and/or a proximate) angle of rotation is detected, a fixed acceleration threshold may be adjusted (e.g., raised) to not result in a content rotation the next time the same (and/or a proximate) acceleration is detected, and/or a fixed angular velocity threshold may be adjusted (e.g., raised) to not result in a content rotation the next time the same (and/or a proximate) angular velocity is detected.

Before moving on to the description of FIG. 6, it is to be understood that in addition to fixed thresholds, thresholds listed in a data table such as the data table 400 that may vary based on a detected acceleration and/or angular velocity of the device may also be adjusted based on a user's selection of either the selector 506 or selector 508.

Now describing FIG. 6, it shows an example UI 600 presentable on a display of a device undertaking present principles so that a user may configure settings of the device. The UI 600 includes a first option 602 to configure the device to determine whether to rotate content presented on the display based on a detected angle of rotation (when check box 604 is selected), to determine whether to rotate content based on a detected acceleration during rotation (when check box 606 is selected), and to determine whether to rotate content based on a detected angular velocity during rotation (when check box 608 is selected). One or more of the boxes 604-608 may be simultaneously selected in some embodiments.

In addition to or in lieu of the first option 602, the UI 600 may include a second option 610 for a user to select which type of data to use to determine whether to rotate content presented on the display in accordance with present principles. Thus, use of acceleration data may be selected (based on selection of check box 612), use of angular velocity data may be selected (based on selection of check box 614), and use of both acceleration data and angular velocity data may be selected (based on selection of check box 616).

The UI 600 may also include an option 618 for a user to configure the device to rotate content presented on the display “easier” at faster “speeds” (e.g., acceleration and/or angular velocity) than at slower “speeds” (when check box 620 is selected), or to rotate content presented on the display “easier” at slower “speeds” than at faster “speeds” (when check box 622 is selected). The device may allow for “easier” rotation based on adjustment to and/or selection of various thresholds to be used by the device in various contexts as described herein, such as by using a relatively smaller angle of rotation threshold for a relatively faster detected acceleration than if a relatively slower acceleration were detected.

Still further, the UI 600 may include an option 624 (selectable using radio button 626) to configure the device to learn a user's rotation habits as the user continues to interact with the device to rotate content as described herein. Thus, for instance, selection of option 624 by the user may cause the device to undertake actions described above in reference to FIG. 5.

Also shown in FIG. 6 is an option 628 for a user to configure various thresholds to be used in accordance with present principles, such as the fixed thresholds described above. Thus, an angle of rotation threshold may be established using numerical input box 630, an acceleration threshold may be established using numerical input box 632, and an angular velocity threshold may be established using numerical input box 634. Also, note that the example UI 600 shown in FIG. 6 may include a selector 636 that is selectable to automatically without further user input cause representations of the data tables described herein to be presented (such as a representation of the table 400) at which a user may configure and/or adjust various angle of rotation thresholds for corresponding accelerations (and/or acceleration ranges) and/or angular velocities (and/or angular velocity ranges) in the respective table being configured.

Moving on from the description of FIG. 6, it is to be understood in accordance with present principles that in some embodiments where an acceleration threshold and/or angular velocity threshold is to be used to determine whether to rotate content presented on a display, but where an angle of rotation threshold is to not be used, the device may only make such a determination if it detects (e.g., continual) acceleration and/or angular velocity for at least a threshold amount of time (such as two seconds) which may be configured by a user, device manufacturer, and/or device administrator (e.g., by providing input to a UI such as the UI 600 to establish the threshold amount of time), while in other embodiments the device may make such a determination if it detects acceleration and/or angular velocity for any amount of time.

It is to also be understood in accordance with present principles that a rotation of content presented on a display from a landscape orientation to a portrait orientation and vice versa may be a rotation of the content (e.g., in its entirety) ninety degrees from its previous orientation in a plane at least parallel to if not established by a plane of the display so that, for example, when a user is looking at the display upright, such as at a viewing angle perpendicular to the direction of gravity at the location of the user while the display of the device is being held in front of the user's face to establish a plane with a Y axis parallel to the direction of gravity, the user may view the content more upright than sideways or upside down.

Still further, it is to be understood that the actions described herein as being performed by the device, such as the logic of FIG. 3, may be executed by a device's operating system (e.g., host or guest operating system), and/or by a specific and/or individual application being executed at the device, such as a news application, weather application, video player application, etc.

Providing a few more examples of present principles, suppose a user rotates a device relatively fast, which introduces relatively high angular velocity and acceleration. Even if the rotation has satisfied a fixed angle of rotation threshold for which content is to be rotated, the movement may nonetheless be ignored and hence the orientation of presented content not changed if a relatively higher angle of rotation threshold that varies based on an amount of acceleration and/or angular velocity is not met based on the detected movement of the device, and thus the movement may be determined to be accidental for which content should not be rotated.

As another example, suppose a user rotates a device relatively slow, which introduces relatively low angular velocity and acceleration. Even if the rotation has not satisfied a fixed angle of rotation threshold for which content is to be rotated, the movement may nonetheless be processed as a content rotation request and hence the orientation of presented content may be changed if a relatively lower angle of rotation threshold that varies based on an amount of acceleration and/or angular velocity is met based on the detected movement of the device.

As yet another example, if relatively frequent (e.g., occurring within a threshold amount of time from each other), relatively high speed rotations of the device occur as detected by the device, such movements may be ignored and hence the orientation of presented content not changed owing to the device determining that the rotations were accidental ones for which content should not be rotated based on the rotations each being above certain acceleration/angular velocity thresholds within the threshold amount of time.

Nonetheless, it is to be further understood that (e.g., based on user-configured settings), a relatively high speed rotation of a device may be identified as a request to rotate content for one user but not a request to rotate content for another user, such as based on user-configured settings.

Before concluding, it is to be understood that although a software application for undertaking present principles may be vended with a device such as the system 100, present principles apply in instances where such an application is downloaded from a server to a device over a network such as the Internet. Furthermore, present principles apply in instances where such an application is included on a computer readable storage medium that is being vended and/or provided, where the computer readable storage medium is not a transitory signal and/or a signal per se.

While the particular DETERMINING WHETHER TO ROTATE CONTENT BASED ON IDENTIFICATION OF ANGULAR VELOCITY AND/OR ACCELERATION OF DEVICE is herein shown and described in detail, it is to be understood that the subject matter which is encompassed by the present application is limited only by the claims.

1. A device, comprising:
a processor;
a motion sensor accessible to the processor;
a display accessible to the processor; and
storage accessible to the processor and bearing instructions executable by the processor to:
identify, based at least in part on input from the motion sensor, one or more of an angular velocity of the device and an acceleration of the device;
determine whether to rotate content presented on the display based at least in part on the identification; and
present at least one user interface (UI) responsive to the input from the motion sensor, the UI comprising:
an indication that the device has been moved; and
a prompt for input to rotate the content based on detected device motion.

2. The device of claim 1, wherein the instructions are executable by the processor to:
identify, based at least in part on input from the motion sensor, at least the angular velocity of the device; and
determine whether to rotate content presented on the display based at least in part on the identification.

3. The device of claim 2, wherein the instructions are executable by the processor to:
determine whether the angular velocity is at least one of equal to and greater than an angular velocity threshold; and
determine whether to rotate content presented on the display based at least in part on whether the angular velocity is at least one of equal to and greater than the angular velocity threshold.

4. The device of claim 2, wherein the instructions are executable by the processor to:
determine whether the angular velocity is at least one of equal to and less than an angular velocity threshold; and
determine whether to rotate content presented on the display based at least in part on whether the angular velocity is at least one of equal to and less than the angular velocity threshold.

5. The device of claim 2, wherein the instructions are executable by the processor to:
identify, based at least in part on the angular velocity of the device, an angle of rotation threshold; and
determine whether to rotate content presented on the display based at least in part on a comparison of an identified angle of rotation of the device to the angle of rotation threshold.

6. The device of claim 5, wherein the angle of rotation threshold is identified from data accessible to the device that correlates at least one of angular velocities to respective angle of rotation thresholds and angular velocity ranges to respective angle of rotation thresholds.

7. The device of claim 1, wherein the instructions are executable by the processor to:
identify, based at least in part on input from the motion sensor, at least the acceleration of the device; and
determine whether to rotate content presented on the display based at least in part on the identification.

8. The device of claim 7, wherein the instructions are executable by the processor to:
determine whether the acceleration is at least one of equal to and greater than an acceleration threshold; and
determine whether to rotate content presented on the display based at least in part on whether the acceleration is at least one of equal to and greater than the angular velocity threshold.

9. The device of claim 7, wherein the instructions are executable by the processor to:
determine whether the acceleration is at least one of equal to and less than an acceleration threshold; and
determine whether to rotate content presented on the display based at least in part on whether the acceleration is at least one of equal to and less than the angular velocity threshold.

10. The device of claim 7, wherein the instructions are executable by the processor to:
identify, based at least in part on the acceleration of the device, an angle of rotation threshold; and
determine whether to rotate content presented on the display based at least in part on a comparison of an identified angle of rotation of the device to the angle of rotation threshold.

11. The device of claim 10, wherein the angle of rotation threshold is identified from data accessible to the device that correlates at least one of accelerations to respective angle of rotation thresholds and acceleration ranges to respective angle of rotation thresholds.

12. The device of claim 1, wherein the instructions are executable by the processor to:
identify, based at least in part on input from the motion sensor, both of the angular velocity of the device and the acceleration of the device; and
determine whether to rotate content presented on the display based at least in part on the identification.

13. The device of claim 1, wherein the instructions are executable by the processor to:
rotate content presented on the display based at least in part on the identification, the rotation being one of: from a landscape orientation to a portrait orientation, from a portrait orientation to a landscape orientation.

14. The device of claim 1, wherein the motion sensor comprises one or more of: an accelerometer, a gyroscope.

15. A method, comprising:
identifying one or more of an angular velocity of a device and an acceleration of the device;
determining whether to rotate content presented on a display based at least in part on the identifying;
presenting at least one user interface (UI) comprising at least a first selector selectable to provide input to rotate the content responsive to the identifying and at least a second selector selectable to provide input to not rotate the content responsive to the identifying.

16. The method of claim 15, comprising:
identifying at least the angular velocity of the device;
comparing the angular velocity to an angular velocity threshold; and
determining whether to rotate content presented on the display based at least in part on the comparing of the angular velocity to the angular velocity threshold.

17. The method of claim 15, comprising:
identifying at least the angular velocity of the device;
identifying, based at least in part on the angular velocity of the device, an angle of rotation threshold;
identifying an actual angle of rotation of the device;
comparing the actual angle of rotation to the angle of rotation threshold; and
determining whether to rotate content presented on the display based at least in part the comparing of the actual angle of rotation to the angle of rotation threshold.

18. The method of claim 15, comprising:
identifying at least the acceleration of the device;
comparing the acceleration to an acceleration threshold; and
determining whether to rotate content presented on the display based at least in part on the comparing of the acceleration to the acceleration threshold.

19. The method of claim 15, comprising:
identifying at least the acceleration of the device;
identifying, based at least in part on the acceleration of the device, an angle of rotation threshold;
identifying an actual angle of rotation of the device;
comparing the actual angle of rotation to the angle of rotation threshold; and
determining whether to rotate content presented on the display based at least in part the comparing of the actual angle of rotation to the angle of rotation threshold.

20. An apparatus, comprising:
a first processor;
a network adapter; and
storage bearing instructions executable by a second processor of a device for:
identifying one or more of an acceleration of the device and an angular velocity of the device in at least two dimensions;
determining whether to adjust presentation of content presented on a display of the device based at least in part on the identifying;
present at least one user interface (UI) comprising two or more of:
a first selector selectable to configure the apparatus to determine whether to rotate content presented on the display based on an angle of rotation, a second selector selectable to configure the apparatus to determine whether to rotate content presented on the display based on an acceleration, and a third selector selectable to configure the apparatus to determine whether to rotate content presented on the display based on annular velocity during rotation,
wherein the first processor transfers the instructions to the second processor over a network via the network adapter.
